(19) United States
(12) Patent Application Publication
(10) Pub. No.: US 2018/0089213 A1
(43) Pub. Date: Mar. 29, 2018

(54) Process for Searching for a Place

(71) Applicant: Morou Boukari, Toulouse (FR)

(72) Inventor: Morou Boukari, Toulouse (FR)

(21) Appl. No.: 15/783,962

(22) Filed: Oct. 13, 2017

Related U.S. Application Data
(63) Continuation-in-part of application No. 14/739,426, filed on Jun. 15, 2015.
(60) Provisional application No. 62/012,437, filed on Jun. 16, 2014.
(60) Provisional application No. 62/410,506, filed on Oct. 20, 2016.
(60) Provisional application No. 62/414,294, filed on Oct. 28, 2016.

(51) Int. Cl. G06F 17/30

(52) U.S. Cl. CPC G06F 17/3097; G06F 17/30991; G06F 17/30867; G06F 17/30241

(57) ABSTRACT

The invention relates to a method for searching for a place on the basis of a free request of parameters defined by a user on a peripheral unit connected to a central unit, notable in that it comprises the following steps:
selecting and grouping types of parameters,
spatial cutting of the earth's surface or planets, asteroids or comets in surface cells, said cells being associated with a plurality of sensors,
associating data with a type of parameters and with a surface cell in order to obtain data sub-sets,
processing and storing the data sub-sets,
constituting the free request,
analyzing the language and the interpretation of the free request,
searching for and selecting surface cells associated with the sorted and selected data,
displaying the place corresponding to the surface cells found.
Uses: accelerating the search for a place.

### SCOPE OF THE INVENTION

This invention relates to the field of searching for a place and in particular to adaptations making it possible to perform sais searches under the best conditions.

### DESCRIPTION OF THE PRIOR ART

Normally, one may spend several days obtaining complete information on the destination of a place, in particular for a vacation. It is indeed necessary today to consult multiple sources of information, which are often incomplete and dispersed throughout the world.

Document US2014279261 describes methods, systems and devices comprising computer programs encoded on computer storage supports, intended for computerized travel services. One of the methods comprises the following operations: receiving a travel request; identifying points of interest or destinations associated with a place of travel; for each one of the points of interest or destinations: determining photographs which are geographically associated with the point of interest or with the destination, selecting a photograph selected from the photographs; obtaining a description associated with the point of interest or with the destination, obtaining a price for a hotel associated with the point of interest or with the destination and obtaining a price for a flight corresponding to the point of interest or to the destination; and, for each one of the points of interest or destinations, transmitting a result relative to the request comprising the selected photographs, the description, the respective hotel prices and prices for flights.

This document does not precisely describe the technical characteristics that stake it possible to implement the invention and in particular those making it possible to make available to the user the data that he is searching for. As such, although this document calls for a search in natural language, this language is used to give the name of the place or of the destination requested by the user but not for searching a place on the basis of the desired parameters.

### DESCRIPTION OF THE INVENTION

The applicant has therefore conducted research intended to enable any person at any institution or organization (civil or military) to locate and choose a place in the entire world to stay temporarily, work, etc., without knowing the name of said place, but by transmitting wishes or desires of what the person would like to encounter, see, feel, live or do there and so on.

Another objective of the invention is to obtain this result very quickly and thus save an enormous amount of time by avoiding the need to consult multiple sources of information.

To do this, the applicant has imagined a new, reverse search method, allowing any person, at any institution or organization (civil or military; to identify and choose a terrestrial or extraterrestrial place to stay, work, without knowing the name of this place beforehand, but by transmitting, through a request which could be a free request or a free request in natural language about at least one peripheral questioning unit, the wishes or desires of what they want to encounter, see, feel, live or do there,

which desire or wishes which could contain climatic, environmental, socioeconomic, political, military, security, strategic, sanitary, housing conditions, with their qualitative and quantitative associated values,

which peripheral unit or client computer, is equipped with artificial intelligence, analyzing and interpreting the request and enabling their to interact with the user,

which client computer is connected by digital network to a server, or central unit,

which central unit or server contains at least the recorded data coining from recording sensors associated with each surface cell coming from the spatial cutting of the Earth's surface, or planets, asteroids or comets in surface cells,

which sensors measure the parameters which can be identified from surface cells, which parameters being of the type climatic, environmental, logistic, geographic, sanitary and time-related and

which surface cutting can come from the grouping of parameters or dialogue between artificial intelligence (software) and the user,

which artificial intelligence (software) contained in the peripheral unit (client computer) analyses, interprets the request, identifies the parameters and the type of parameters, recognizes in this request a value, a quantification which will come corresponding to the quantification of parameters proposed by the recording sensors and generates keywords and conditions for sorting and selecting data stored on the central unit and coming from the recording sensors associated with each surface cell coming from the grouping of parameters and spatial cutting of the Earth's surface in surface cells and measuring the parameters that can be identified from the surface cells,

which parameters being climatic, environmental, logistic, geographic/sanitary and time-related,

which keywords and sorting conditions allow to search and select the surface cells associated with the sorted and selected data stored in the central unit and to supply on said at least one peripheral questioning unit the place(s) corresponding to the surface cells found and the parameters defined in the user's request,

which parameters which could also be proposed to the user by the software (artificial intelligence) for the purpose of search optimization.

The method thus proposes a reverse search. Such a reversal of the search enables to very quickly supply to the user of the method, a place or a plurality of places corresponding to the parameters defined in the request by the user.

Thus, by simply expressing a wish or desires, for example for activities, climatic, environmental, socioeconomic, political, military, security, strategic, sanitary, and housing conditions, the user may obtain one or more places as a response.

The free request is carried out in natural language. This is software that recognizes the words used in the request to generate keywords and/or to identify the parameters or the type of parameters.

In addition to the identification of the parameters that can be quantified, the software, the artificial intelligence also recognizes in the request a value, a quantification that will come into correspondence with the quantification of the parameters proposed by the recording sensors.

The method of the invention enables accelerated searches and thus saves time. It also makes it possible to perform more complete searches beyond just the terrestrial globe.

The recording sensors can be sold or hired lucratively by a third-party economic entity to any other economic or administrative entity that has the responsibility of managing the cell or grouping of surface cells or that has interests in each cell or grouping of surface cells.

Furthermore, according to another advantageous characteristic of the invention, recording sensors communicate with each other by means of an air and/or spatial and/or terrestrial communication network (made available and/or managed lucratively by a third-party economic entity).

The values of the parameters that can be measured by the recording sensors are recorded in the central unit, combined with at least the valuation data of the economic, touristic, cultural and social advantages of each unit or surface unit groupings, which the valuation data of the economic, touristic, cultural and social advantages are sponsored by the administrative entities managing each surface unit or groups of surface units or by economic entities that have interests in each surface unit or groupings of surface units.

The logistic means are means for accessing the place(s) found by a space shuttle, car, train, airplane, air taxi, animals, on foot and housing means. However, according to another characteristic of the invention, the method consists of systematically integrating into the displayed response and once at least one identified place, at least one of the following lists:

transport available onsite or enabling said place to be reached,

housing capacities of the place,

restoration capacities of the place,

economic activities of the place,

touristic activities of the place,

educational activities.

According to an embodiment, it is all of these lists which are made available to the user.

Transport available onsite or enabling said place to be reached can be of the following types:

air transport (airplanes, drones, helicopters, etc.),

land transport (train, wheeled vehicles, etc.),

sea transport.

According to another embodiment, one or several of these lists are made available to the user to refine their place search before final selection.

The geographical location can foe the location of the place in relation to water points, such as the sea, oceans, rivers and streams, location in relation to mountains, craters, volcanoes.

Sanitary criteria concern sanitary risks linked with water, food.

Time parameters are, for example, the departure and return date.

Valuation data are, for example, economic, touristic, cultural and social advantages.

The presentation of the places and values of the associated parameters can be made in the form of text, still images, animated images, sound, 3D representation, etc.

According to another particularly advantageous characteristic of the invention, the method consists of proposing, with the response found, more details about the place(s) presented, such as contained, from the access and housing means, valuation data from the economic, touristic, cultural and social advantages sponsored by administrative entities managing each surface cell or groupings of surface cells or by economic entities that have interests in each surface cell or groupings of surface cells to lead the person to explore them so as to generate financial revenue by consulting sponsored data, which the revenue is paid by sponsoring entities and possibly by the person searching for the place or places.

There is a plurality of known technical means used to carry out the cutting of the earth's surface such as the cutting proposed by the standard ISO 3166-1 alpha 2 or alpha 3 or digital alpha. This international standard is used for cutting the world into countries with the assigning of a code to each country. The standard ISO-3166-1 alpha 2 or alpha 3 or digital alpha can be combined with standard ISO 3166-2 which is used for the cutting of each country into subdivisions with the assigning of a code to each subdivision.

The standard ISO 3166 (-1 and -25 is already used by banks for transferring money (bank code making it possible to see where the bank is located), for airlines for transporting passengers and freight (country code, city, airport) and also for sending mail by post.

Another existing technical means for spatial cutting is that known as NUTS (Nomenclature of Units for Territorial Statistics) and LAU (Local Administrative Units). LAUs are a subdivision of the NUTS. NUTS are conventionally used by EUROSTAT and many other countries. NUTS correspond, in a country, to the regions and LAUs to the towns.

The techniques according to ISO 3166 (-1 and -2) or that of NUTS and LAU result in the cutting of the earth's surface into countries, of the countries into regions and of the regions into towns.

The size of the surface units varies according to the continents, according to the countries and according to the regions.

The invention therefore does not propose an assigning of geographical coordinates (longitude, latitude, altitude) to a given location. This is also not about using GPS or GIS (Geographic Information System) techniques known in the prior art and which use geographical coordinates (longitude, latitude, altitude) for storing data linked to a point of interest.

According to the type of parameters, the cutting can be different and more or less accurate. Starting from the moment when, after a first search, a different cutting can be proposed, the software requires from the user more specifications linked to the parameter or parameters identified before displaying the location or locations identified as responding to the parameters searched. The cutting can also be different according to the search finding, as a response, a place on earth or beyond the surface of the planet Earth.

Likewise, starting from the moment when a quantification is possible and available according to the parameter identified in the request without this quantification being itself detected in the request, the software requires more specifications linked to the quantification of said parameter. As such, according to another particularly advantageous characteristic of the invention, the method comprises the following operation:

proposing to the user once the first search is carried out, quantifications for the parameters identified for the purpose of optimizing the search.

According to another particularly advantageous characteristic of the invention, the method comprises the following operation:

proposing to the user once the first search is carried out, types of parameters available but different from those identified in their request for the purpose of optimizing the search.

This method requires the sorting, parameterization and storage of a large amount of data. Moreover, the applicant has advantageously imagined another method characteristic which is notable, in that it comprises the production of data sub-sets, each having the following data fields:

geographical name or names of the surface cell,

the type of parameter associated with said surface cell,

the nature of said parameter,

the quantification of said parameter,

the temporal validity of the quantification of said parameter,

the date/time of update of the preceding fields,

the source/origin of the fields completed.

The type of parameters depends on the recording sensors present in said surface cells and the data that they are likely to provide. It is understood, that for a place located beyond the earth's surface (atmosphere, Earth's orbit, other planets, asteroids, comets), the recording sensors are those equipping the probes and other space vehicles sent from Earth, or measuring means available on Earth or in the Earth's orbit, and capable of taking these measurements remotely.

As such, according to a particularly advantageous characteristic of the invention, these sensors are sensors that measure parameters of the meteorological type such as:

sensors for measuring temperature,

sensors for measuring humidity,

sensors for measuring atmospheric pressure,

sensors for measuring rainfall,

sensors for measuring sunshine,

sensors for measuring wind speed,

sensors for measuring snowfall,

sensors for measuring wave heights,

etc.

Whether or not associated with these data sensors, other sensors that can be qualified in qualitative terms measure other parameters such as:

sensors for measuring air pollution,

sensors for measuring water pollution,

sensors for measuring the visitation frequency of the places,

sensors for measuring insecurity,

sensors for measuring the health risk linked to food,

sensors for receiving data on airline flights for reservations,

etc.

The various data sub-sets formed by the data coming from measurements taken by said sensors ensure to the user that the various parameters of his request are taken into account.

In order to make it possible to obtain a search result going beyond a search for vacation spots, but also in order to complement the latter, the applicant has advantageously imagined the creation of sub-sets of unreported data.

Thus, according to another particularly advantageous feature, the parameter type is political. Indeed, it should be noted that the destinations proposed and the destinations where it is, for example, dangerous to go may not match up. Such a difference requires the consultation of multiple information sites (for example a travel site and the site of the department of foreign affairs). The invention makes it possible to do without this type of resource so as to avoid the need to consult multiple sites.

According to another particularly advantageous feature, the parameter type is military. Indeed, for military missions, it is important to know whether, in the location where it is envisaged to conduct military operations with a possible quick withdrawal of troops, there is/are:

a military base for the country of origin of the troops, a military base for an ally country, a military base for an enemy country;

logistics support cells for the country of origin of the troops, logistics support cells for an ally country, logistics support cells for an enemy country;

intelligence officers for the country of origin of the troops, intelligence officers for an ally country, intelligence officers for an enemy country;

hostilities among the local populations with regard to nationals of the country of origin of the troops.

According to another particularly advantageous feature, the parameter type is educational. Such a data sub-set may satisfy requests concerning a training request.

According to another particularly advantageous feature, the parameter type is of a sanitary nature. Such a data sub-set may complement responses to requests requiring the presence of a vaccine.

According to another particularly advantageous feature, the parameter type is administrative. Such a data sub-set may complement responses to requests requiring administrative formalities.

According to another particularly advantageous feature, the parameter type is of a security nature.

According to another particularly advantageous feature, the parameter type is geopolitical and strategic.

According to another particularly advantageous feature, the parameter type is environmental.

The invention also relates to the device enabling said method to be implemented, and which is notable in that it comprises at least one server for storing and managing said data sub-sets with which the data entry modules provided by the recording sensors and search modules in said data sub-sets communicate.

This server is connected by a digital network to at least one client computer having artificial intelligence for analysis and interpretation of the free request enabling it to interact with the user so as to collect a character string representing the free request and also provide the user with results in the form of multimedia documents (text, animated or still images, sound, 3D representations, etc.).

More specifically, the device comprises at least one said server unit containing data sub-sets organized in bytes, each byte being comprised in particular of the data listed above for the sub-sets defined above.

According to another feature, the device is notable in that each surface cell or set of surface cells comprises a plurality of recording sensors of at least one identifiable parameter.

Examples of technologies that can implement the measurement of parameters described hereinabove are numerous. However, among the latter, the applicant has carried out the selection of the following devices.

In order to implement the measuring of rainfall, the device of the invention comprises, in the surface cell, a sensor that measures the variations of a light ray due to the refraction caused by the presence of water.

In order to implement the measuring of sunshine, the device of the invention comprises an array of photodiodes arranged according to a particular geometry that measures the radiation. The use of several photodiodes ensures that at least one directly receives the solar radiation and allows for accurate measurement in all conditions. At least one photo detector receives the light directly from the sun (in addition to the diffuse component), the photodiodes which are not directly illuminated by the sun, are used to measure the diffused light which is subtracted from the measurement of the sensor that directly sees the sun in order to obtain direct radiation.

In order to implement the measuring of snowfall, the device of the invention comprises a satellite that, carrying optical sensors, produces images of the snow cover of the surface cell concerned. The sensor is then not physically present in the surface cell. The images obtained are treated by different algorithms in order to determine snowfall.

Whether or not in association with the preceding characteristic in order to carry out the same function, the device of the invention comprises a distance sensor that measures the delay between the transmitting and receiving of an emitted acoustic pulse which as such makes it possible to measure the thickness of a layer of snow.

In order to implement the measuring of the speed of the wind, the device comprises a weather vane module associated with a horizontal wind turbine. According to another technology, the device comprises a temperature measurement probe whereon the cooling effect caused by the wind is measured.

In order to implement the measuring of the height of waves, the device comprises an immersed acoustic current profiler. Whether or not associated with the preceding characteristic in order to carry out the same function, the device further comprises an immersed velocimeter and/or a current meter.

In order to implement the measuring of the quality or of the pollution of the water and participate in the parameter of the environmental type, the device comprises glass capillary tubes provided with specific antibodies and LEDs used in medical imaging for the purpose of detecting Escherichia coli bacteria. Other detection modules are able to test for the presence of heavy metals such as mercury, iron, arsenic, chromium, lead or cyanide in the water.

According to another characteristic, the device comprises a multifunction probe that simultaneously analyses thirteen parameters.

There are also prepositioned measuring stations for measuring the quality of the surface water that, forming networks, are able to be utilized for the implementation of the invention.

In order to implement the measuring of the air pollution, there is a plurality of technical means for measuring the characteristic indicators of the quality of the air such as:

the quantity of Volatile Organic Compounds,

the level of carbon dioxide,

the level of carbon monoxide,

the level of fine particles,

the temperature,

the level of relative humidity,

dust,

nitrogen dioxide,

ozone,

sulfur dioxide,

the quantity of pollens.

As for the quality of the water, there are stations that are already prepositioned for measuring the quality of the air which, forming networks, are able to be utilized for the implementation of the invention.

According to another characteristic of the invention, the device comprises a sensor for receiving air data.

According to another characteristic of the invention, the device comprises a recording sensor for flight offers from airlines.

In order to provide data on the less habitual parameters in the framework of searching for a destination, the invention further comprises original sensors that provide information on original parameters.

As such, for example, in order to implement the measuring of the visitation frequency, the device comprises a module for geolocating tourists which makes it possible to know their positions and their movements. This locating module can comprise a sensor associated with each tourist or depend on a mobile application. The visitation frequency data can also be supplied by the establishments that receive said tourists.

According to another technology, the device comprises a camera associated with software for detecting the presence of a human face. It is then possible to provide frequency and movement data on the persons detected for the purpose of implementing the method of the invention. According to another characteristic, the device comprises a network of small video sensors placed at certain key locations associated with software for detecting the presence of a human face.

According to another characteristic, the device comprises a sensor that detects around it, the presence of mobile telephones that ensure the supply of visitation frequency data for a location.

In order to implement the measuring of the insecurity on a surface cell and participate in the parameter of the security type, there are applications for mobile telephone that provide information on the level of insecurity according to the geolocalization and the time of day. Such an application is based on public data and reports from bodies responsible for security. This data can be used directly or through the intermediary of the application in order to supply this parameter for the implementing of the invention.

According to another characteristic, the device comprises a camera coupled to software for analyzing behavior in order to identify suspicious behavior.

In order to implement the measuring of food insecurity in a surface cell, the device comprises a sensor that makes it possible to detect the molecules produced during the decomposition of food (ethanol, biogenic amines, etc.) in the packaging of food present in said surface cell. According to another characteristic this sensor is a radiofrequency label of the RFID type.

According to another characteristic, the sensor measures the permittivity of the food for the purpose of determining if the permittivity measured corresponds to that of a fresh food or that of a contaminated food.

It appears that a plurality of the technical means is likely to supply all or a portion of the parameters searched. These technical means can already be prepositioned on the surface cells and then be used for this new function namely the supply of data that can respond to the requests from users of the method of the invention. Likewise, several means of measuring are able to supply data concerning several of the parameters searched, without all of them being used. It is therefore not necessary to install a sensor dedicated to each parameter searched.

It is further understood that, according to the parameter measured, the sensors supply the data concerning a single surface cell or a plurality.

In addition, it appears that a plurality of parameters is able to be measured or recorded using mobile modules that can be connected or integrated into mobile telephones. As these telephones can be geolocalized, it is then possible to have for surface cells concerned, measured localized data.

Finally, most of the sensors can be connected to a network in order to store the data measured and make it available.

According to another particularly advantageous characteristic, the method comprises the carrying out of a virtual operation on the place found by the search. This virtual operation has the purpose of said place found being able to have both a function of promoting the identified place and/or enabling the user to travel virtually to said place.

The accounting for the number of responses identifying said place can allow the financial justification of carrying out such an operation.

According to another particularly advantageous characteristic of the invention, said virtual operation is carried out by utilizing the parameters measured by said recording sensors associated with said place found. The virtual operation is therefore carried out according to the parameters actually measured in the identified place and provides the user with a possibility to immerse themselves in real conditions. Of course, the virtual operation can also consider the means of transport chosen.

The fundamental concepts of the invention disclosed above in their most basic form, other details and characteristics will become clearer in view of the following description and the appended drawings, providing, by way of a non-limiting example, an embodiment of a device according to the invention.

### BRIEF DESCRIPTION OF THE DRAWINGS

FIG. 1 is a diagram of an embodiment of a digital network according to the invention.

FIG. 2 is a diagram illustrating the structure of the data sub-sets on one type of parameters,

FIG. 3 is a diagram illustrating the structure of the data sub-sets on another type of parameters,

FIG. 4 is a diagram illustrating the structure of the data sub-sets on another type of parameters,

FIG. 5 is a diagram illustrating the structure of the data sub-sets on another type of parameters,

FIG. 6 is a diagram illustrating the structure of the data sub-sets on another type or parameters,

FIG. 7 is a diagram illustrating the structure of the data sub-sets on another type of parameters,

FIG. 8 is a diagram illustrating the structure of the data sub-sets on another type of parameters,

FIG. 9 is a diagram illustrating the structure of the data sub-sets on another type of parameters,

FIG. 10 is a diagram illustrating the structure of the data sub-sets on another type of parameters,

FIG. 11 is a diagram illustrating the structure of the data sub-sets on another type of parameters.

### DESCRIPTION OF A PREFERRED EMBODIMENT

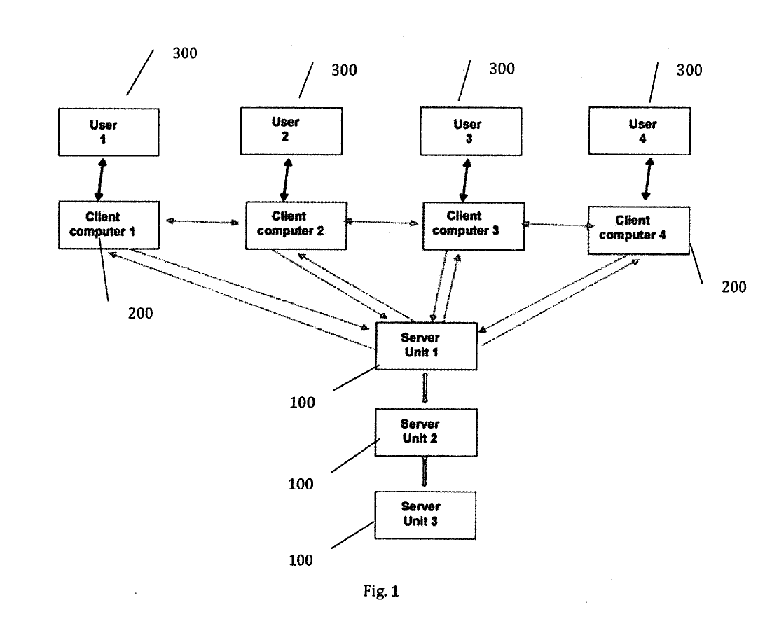

As shown in the drawing of FIG. 1, the reverse search device is comprised of at least one said server unit 100 (reference 3 here) containing a specific document database connected by a digital network to at least one client computer 200 that has artificial intelligence for analysis and interpretation, enabling it to interact with the user 300 so as to collect a character string representing the free request and also provide the user with results in the form of multimedia documents (text, still images, animated images, sound, 3D representation, etc.).

The data of the specific document database of the server unit are in the form of data sub-sets each forming a septuple, each septuple being comprised of:

a surface cell denoted S1 (not shown), obtained from the spatial cutting of the terrestrial globe into basic units,

the parameter type denoted S2 associated with the surface cell S1,

the nature of tee parameter denoted S3,

the quantification of the parameter denoted S4,

The temporal validity of the quantification of the parameter denoted S5 (not shown),

the date/time of update of the quintuple (S1, S2, S3, S4, S5) denoted S6 (now shown),

the source of said quintuple (S1, S2, S3, S4, S5) denoted S7 (not shown).

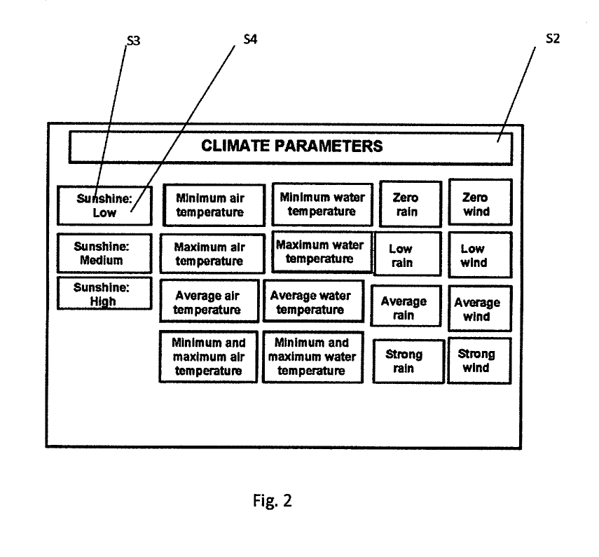

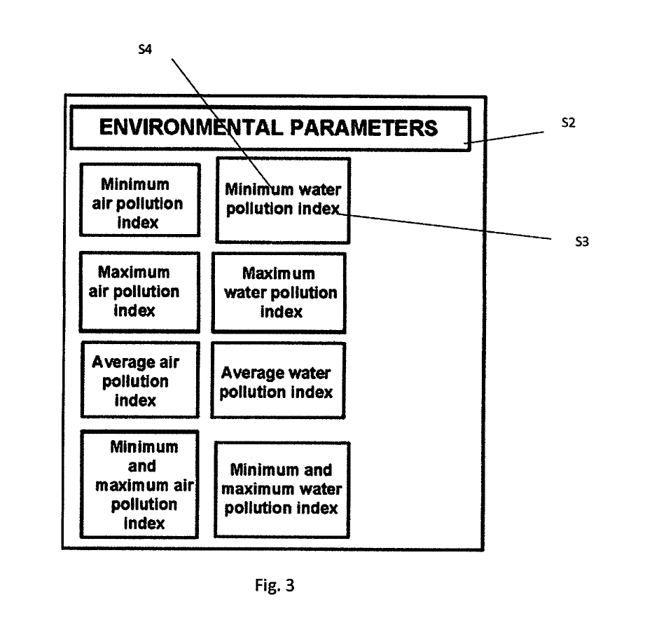

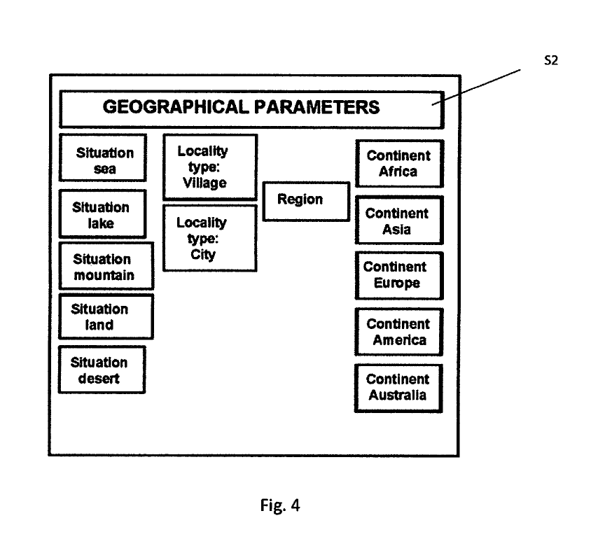

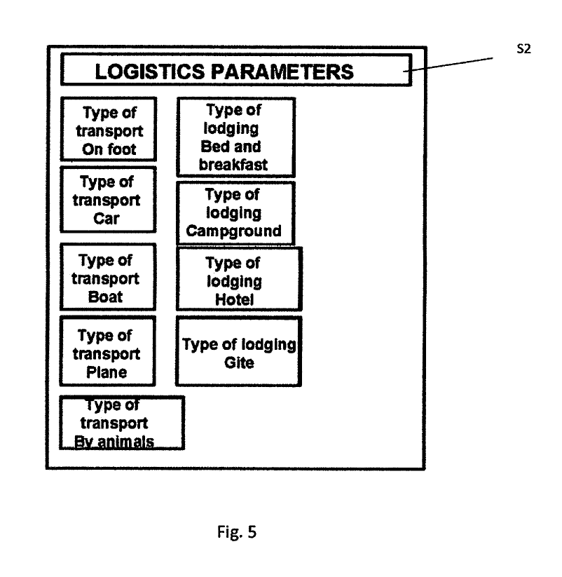

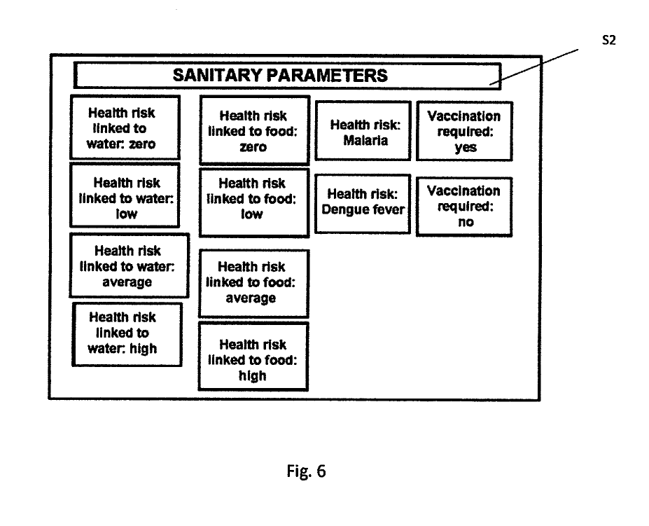

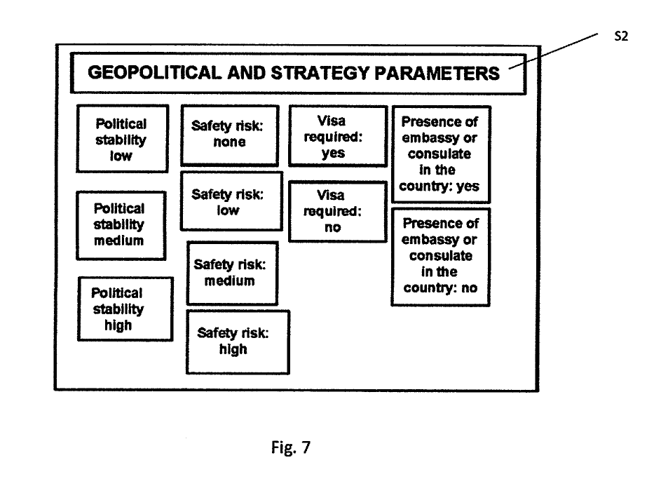

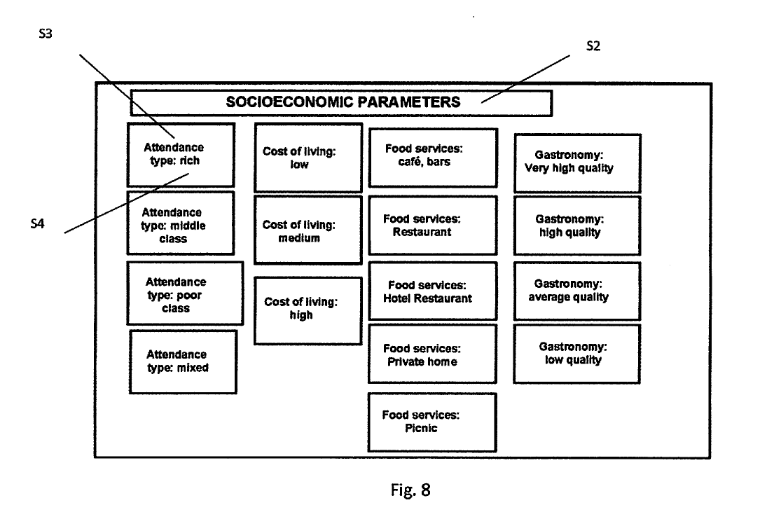

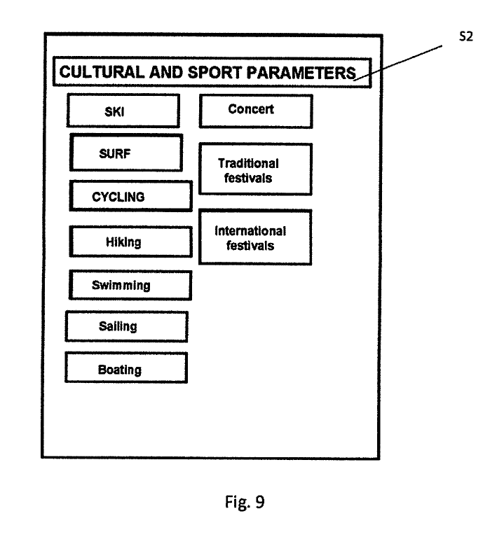

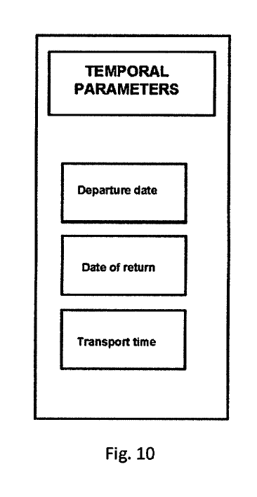

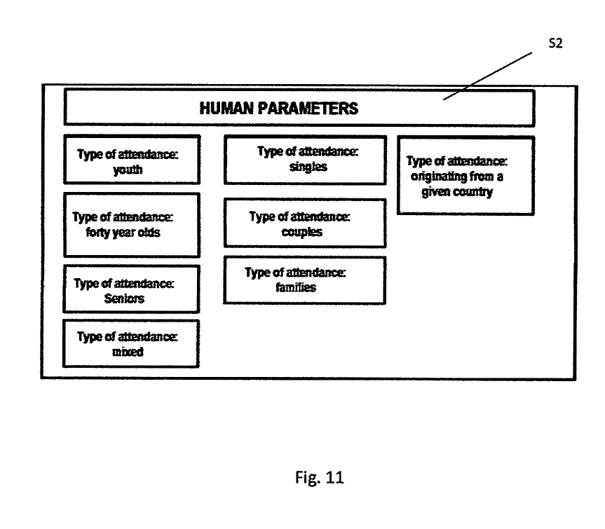

The drawings of FIGS. 1-11 show steps S2, S3 and S4.

The analysis and interpretation of the free request at the level of the peripheral unit or client computer is performed by searching for relevant elements owing to the presence in the artificial intelligence program of one or more series of scripts mating it possible to identify character strings responding to a univocal descriptive syntax. For each relevant element identified, the client computer generates the conditions for the search request, selection and sorting in the database of the data sub-sets contained in the central data processing unit or server computer. The following parts explain how, owing to the existence of a document database, the structure of which is explained, it is possible to search for elements relevant to a user request with an adequate translation.

Thus, on the basis of the structure described above, each data sub-set constitutes a multiplet of seven items, therefore a septuple comprised of S1, S2, S3, S4, S5, S6 and S7, with the following steps:

S1: surface cell;

S2: parameter type;

S3: property of the parameter;

S4: quantification of the parameter;

S5: temporal validity of the quantification of the parameter;

S6: date/time of update of this quintuple;

S7: source of this quintuple.

An example of a data sub-set may be:

(Toulouse; Climatic parameter; air temperature; 25° C. 15 Jun. 2015 2:00 pm-15 Jun. 2015 3:00 pm; Météo-France forecast)

Another example may be:

(Toulouse; Cultural parameter; Gastronomic reputation; good; 2014; Michelin Guide).

An example of a search for relevant elements in the text of the free request (at the level of the client computer) is described below:

Thus, for a free request of the user worded as follows:

“I would like to go to a place with nice weather with a temperature of 25° C. with good gastronomy.”

A series of scripts makes it possible to identify character strings responding to a univocal descriptive syntax.

The simplest case concerns the character strings “Nice weather” or “good gastronomy”.

A more complex case concerns the temperature. It is detected in the text when a series of numbers precedes the strings “° C.” or “° F.” or “° K”.

The translation into requests on the data sub-sets is described below.

For each relevant element identified, conditions are generated for the search request in the database for the data sub-sets.

Example 1: the relevant element “nice weather” is converted into the following condition:

S3=“Air temperature” AND S4 >=20° C.

Example 2: the relevant element “good gastronomy” is converted into the following condition:

S3=“Reputation for gastronomy” AND (S4=“good” OR S4=“superior” OR S4=“excellent”).

The syntaxes of elements of conditions of requests presented above are known in SQL (structured query language” and NoSQL (database management system that is not based on the conventional architecture of relational bases) databases.

The invention makes it possible to obtain a response in less than one minute.

One of the responses to this free request may be:

“Toulouse, France; air temperature; 25°; 15 Jun. 2015 2:00 pm-30 Jun. 2015 3:00 pm”.

It is understood that the method and the device have been described and illustrated for the purpose of disclosure rather than limitation. Of course, various arrangements, modifications and improvements may be made to the above example without going beyond the scope of the invention.

1. Reverse search method, allowing any person, at any institution or organization (civil or military) to identify and choose a terrestrial or extraterrestrial place to stay, work, without knowing the name of this place beforehand, but by transmitting, through a request which could be a free request or a free request in natural language about at least one peripheral questioning unit, the wishes or desires of what they want to encounter, see, feel, live or do there,
which desire or wishes which could contain climatic, environmental, socioeconomic, political, military, security, strategic, sanitary, housing conditions, with their qualitative and quantitative associated values,
which peripheral unit or client computer, is equipped with artificial intelligence, analyzing and interpreting the request and enabling them to interact with the user,
which client computer is connected by digital network to a server, or central unit,
which central unit or server contains at least the recorded data coming from recording sensors associated with each surface cell coming from the spatial cutting of the Earth's surface, or planets, asteroids or comets in surface cells,
which sensors measure the parameters which can be identified from surface cells, which parameters being of the type climatic, environmental, logistic, geographic, sanitary and time-related and
which surface cutting can come from the grouping of parameters or dialog between artificial intelligence (software) and the user,
which artificial intelligence (software) contained in the peripheral unit (client computer) analyzes, interprets the request, identifies the parameters and the type of parameters, recognizes in this request a value, a quantification which will come corresponding to the quantification of parameters proposed by the recording sensors and generates keywords and conditions for sorting and selecting data stored on the central unit and coming from the recording sensors associated with each surface cell coming from the grouping of parameters and spatial cutting of the Earth's surface in surface cells and measuring the parameters that can be identified from the surface cells,
which parameters being of the type climatic, environmental, logistic, geographic, sanitary and time-related,
which keywords and sorting conditions allow to search and select the surface cells associated with the sorted and selected data stored in the central unit and to supply on said at least one peripheral questioning unit the place(s) corresponding to the surface cells found and the parameters defined in the user's request,
which parameters which could also be proposed to the user by the software (artificial intelligence) for the purpose of search optimization.

2. Method according to claim 1, characterized in that it comprises the following step:
proposing to the user once the first search is carried out, types of parameters available but different from those identified in his request for the purpose of optimizing the search.

3. Method according to claim 1, characterized in that it comprises the following step:
proposing to the user once the first search is carried out, quantifications for the parameters identified for the purpose of optimizing the search.

4. Method according to claim 1, characterized in that it comprises the production of data sub-sets, each having the following data fields:
the geographical name or names of the surface cell,
the type of parameter associated with said surface cell,
the nature of said parameter,
the quantification of said parameter,
the temporal validity of the quantification of said parameter,
the date/time of update of the preceding fields,
the source/origin of the fields completed.

5. Method according to claim 2, characterized in that the parameter type is political.

6. Method according to claim 2, characterized in that the parameter type is educational.

7. Method according to claim 2, characterized in that the parameter type is military.

8. Method according to claim 2, characterized in that the parameter type is geopolitical and strategic.

9. Method according to claim 2, characterized in that the parameter type is administrative.

10. Method according to claim 2, characterized in that the parameter type is of a security nature.

11. Method according to claim 1, characterized in that it consists of systematically integrating into the response displayed and both at least one identified place, and at least one of the following lists:
transport available onsite or enabling said place to be reached,
housing capacities of the place,
restoration capacities of the place,
economic activities of the place,
touristic activities of the place,
educational activities.

12. Method according to claim 1, characterized in that it comprises a virtual operation on the place found by the search.

13. Method according to claim 12, characterized in that said virtual operation is carried out by utilizing the parameters measured by said recording sensors associated with said place found.

14. Method according to claim 1, characterized in that it consists of proposing, with the response found, more details about the place(s) presented, such as contained, from the access and housing means, valuation data from the economic, touristic, cultural and social advantages sponsored by administrative entities managing each surface cell or groupings of surface cells or by economic entities that have interests in each surface cell or groupings of surface cells to lead the person to explore them so as to generate financial revenue by consulting sponsored data, which the revenue is paid by sponsoring entities and possibly by the person searching for the place or places.
